(19) United States
(12) Patent Application Publication
(10) Pub. No.: US 2026/0119219 A1
(43) Pub. Date: Apr. 30, 2026

(54) LEVERAGING ARTIFICIAL INTELLIGENCE TO POWER SELF-HEALING

(71) Applicant: Dell Products L.P., Round Rock, TX (US)

(72) Inventors: Dipankar Paul, Bagalore (IN); Wayne D'Entremont, Bradenton, FL (US); Charlotte Chen, Newton, MA (US); Arieh Don, Newton, MA (US)

(73) Assignee: Dell Products L.P., Round Rock, TX (US)

(21) Appl. No.: 18/926,948

(22) Filed: Oct. 25, 2024

(51) Int. Cl. G06F 9/455; G06F 8/41

(52) U.S. Cl. CPC G06F 9/45512; G06F 8/427

(57) ABSTRACT

A method for use in a computing system, comprising: detecting an error; generating a healing script; parsing the healing script to identify a plurality of script lines; displaying a user interface screen that includes a plurality of visualization items, wherein each of the visualization items corresponds to a different one of the plurality of script lines and includes a respective label corresponding to the script line and a respective user interface component, which, when activated, would cause the computing system to execute the script line; and executing the healing script, wherein executing the healing script includes executing each of the script lines only when the respective user interface component that is part of the script line's corresponding visualization item is activated.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided for use in a computing system, comprising: detecting an error; generating a healing script; parsing the healing script to identify a plurality of script lines; displaying a user interface screen that includes a plurality of visualization items, wherein each of the visualization items corresponds to a different one of the plurality of script lines and includes a respective label corresponding to the script line and a respective user interface component, which, when activated, would cause the computing system to execute the script line; and executing the healing script, wherein executing the healing script includes executing each of the script lines only when the respective user interface component that is part of the script line's corresponding visualization item is activated.

According to aspects of the disclosure, a method is provided for use in a computing system, comprising: detecting an error; generating a prompt based on the error by using a first artificial intelligence (AI) engine; providing the prompt to a second AI engine that implements a large language model (LLM); receiving a response to the prompt from the second AI engine; generating a healing script based on the response by using the first AI engine; and executing the healing script.

According to aspects of the disclosure, a system is provided, comprising: a memory; and at least one processor that is operatively coupled to the memory, the at least one processor being configured to perform the operations of: detecting an error; generating a healing script; parsing the healing script to identify a plurality of script lines; displaying a user interface screen that includes a plurality of visualization items, wherein each of the visualization items corresponds to a different one of the plurality of script lines and includes a respective label corresponding to the script line and a respective user interface component, which, when activated, would cause the system to execute the script line; and executing the healing script, wherein executing the healing script includes executing each of the script lines only when the respective user interface component that is part of the script line's corresponding visualization item is activated.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of an error screen, according to aspects of the disclosure;

FIG. 3 is a diagram of an example of a management system, according to aspects of the disclosure;

FIG. 4 is a diagram of an example of a solution manager, according to aspects of the disclosure;

FIG. 5 is a sequence diagram of an example of a process, according to aspects of the disclosure;

FIG. 6 is a diagram of an example of a graphical user interface screen, according to aspects of the disclosure;

FIG. 7 is a diagram of an example of an indicator column, according to aspects of the disclosure;

FIG. 8 is a diagram of an example of a script visualization item, according to aspects of the disclosure;

FIG. 9 is a flowchart of an example of a process, according to aspects of the disclosure;

FIG. 10 is a sequence diagram of an example of a process, according to aspects of the disclosure;

FIG. 11 is a diagram of an example of an artificial intelligence (AI) engine, according to aspects of the disclosure;

FIG. 12 is a diagram of an example of a response that is generated by an AI engine implementing a large language model (LLM), according to aspects of the disclosure;

FIG. 13 is a diagram of an example of a script, according to aspects of the disclosure;

FIG. 14 is a diagram of a label set, according to aspects of the disclosure;

FIG. 15 is a diagram of an example of a computing device, according to aspects of the disclosure; and

FIG. 16 is a diagram of an example of a user interface screen, according to aspects of the disclosure.

### DETAILED DESCRIPTION

The maintenance and service of complex computing systems require extensive knowledge and experience. Obtaining such expertise requires a very long ramp-up/training time, which may entail years of on-the-job experience collection. Such training however may not be always available to customer support (CS) engineers. Traveling CS engineers are especially susceptible to suffering from the lack of such experience because they are normally not co-located with other, and potentially more experienced, CS engineers who they might be able to ask for help. Accordingly, if a traveling CS engineer encounters an issue that requires more experience than what the CS engineer has, the engineer might be unable to resolve the issue or he or she may be forced to spend more time than expected on resolving the issue.

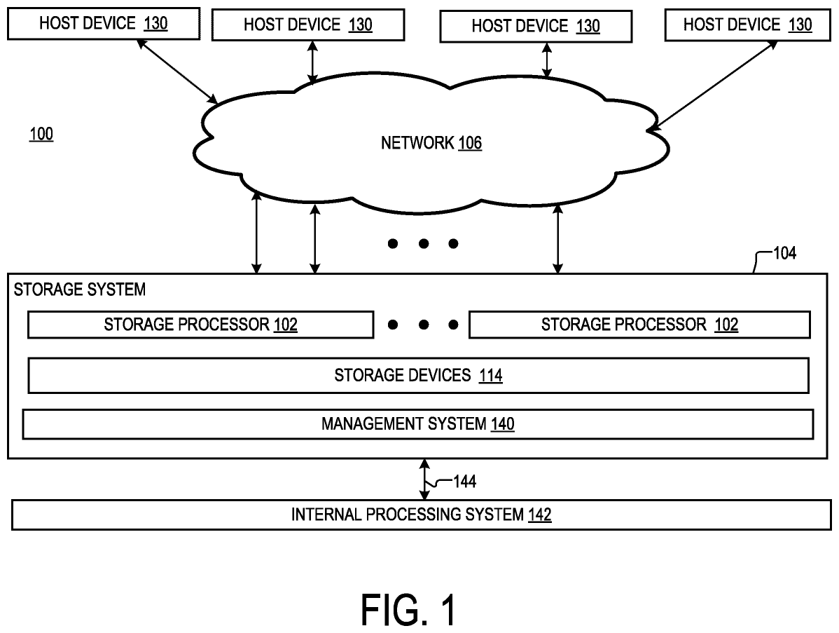

The present disclosure provides a system and methodology that can be used by CS engineers in the troubleshooting of large-scale computing systems. The system and methodology can be used by traveling CS engineers, as well as other engineers. The system and methodology leverages machine learning to generate scripts for addressing problems in large computing systems. Specifically, the system and methodology may receive as input an error that is generated by a large-scale computing system. Based on the error message, the system may generate a script, which when executed on the computing system, would cause the error to be resolved. The operation of the system, in accordance with one particular implementation, is discussed further below with respect to FIGS. 1-16.

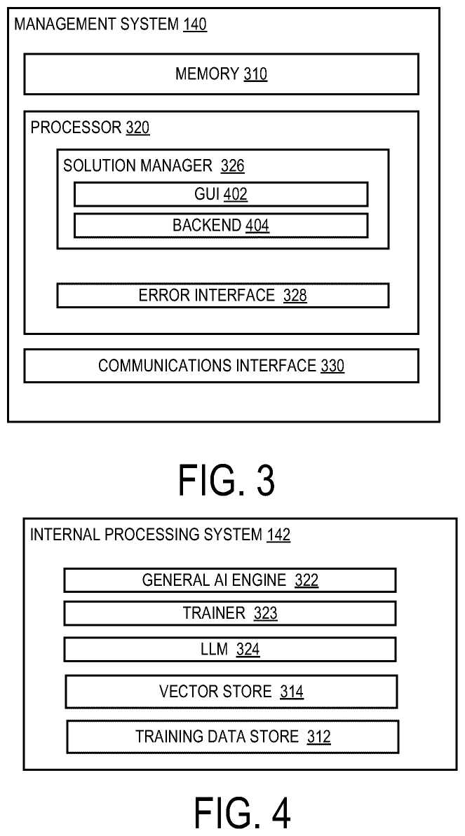

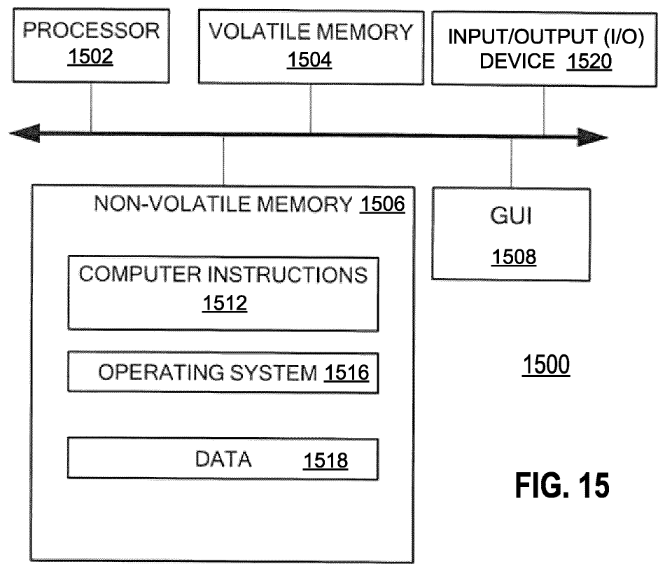

FIG. 1 is a diagram of an example of a system 100, according to aspects of the disclosure. As illustrated, system 100 may include a plurality of host devices 130 that are coupled via a communications network 106 to a storage system 104. Each of the host devices 130 may include a computing device, such as the computing device 1500, which is discussed further below with respect to FIG. 15. Each of the host devices 130 may include one or more of a desktop computer, a smartphone, a laptop, and/or any other suitable type of computing device. The communications network 106 may include one or more of a local area network (LAN), a wide area network (WAN), a wireless network, a cellular network, a 5G network, the Internet, an InfiniBand network, and/or any other suitable type of network. Storage system 104 may include any suitable type of storage system, such as a location-addressable storage system or a content-addressable storage system, for example. Storage system 104 may include a plurality of storage processors 102 and one or more storage devices 114 and a management system 140. The management system 140 may include a computing device that is used for the management of storage system 104. An example of one possible implementation of management system 140 is discussed further below with respect to FIG. 3. Each of storage processors 102 may be a computing device, such as the computing device 1500 that is discussed further below with respect to FIG. 15. Each of storage processors 102 may be configured to receive input-output (I/O) requests from host devices 130 and execute the I/O requests by reading or writing data from storage devices 114. Storage system 104 may be coupled to an internal processing system 142 via a network 144. Network 144 may be a secure internal network. By way of example, network 144 may include a TCP/IP network, an InfiniBand network and/or any other suitable type of network. Internal processing system 142 may include one or more computing devices, such as the computing device 1500, which is discussed further below with respect to FIG. 15. In some implementations, multiple storage systems, may be coupled to the internal processing system via network 144.

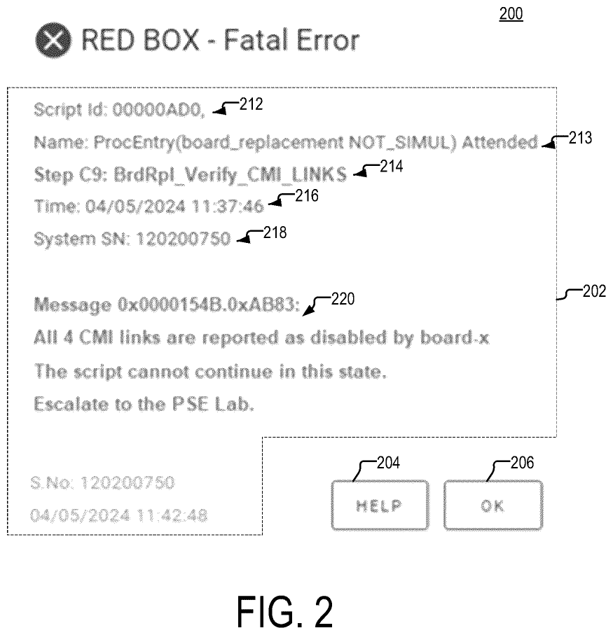

FIG. 2 is a diagram of an example of an error message screen 200, according to aspects of the disclosure. As illustrated, the screen 200 includes an error message 202, a HELP button 204, and an OK button 206. The error message 202 may include a text message, a number, an alphanumerical string, and/or any other suitable type object that contains information about an error that has occurred in the storage system 104. According to the present example, the error message 202 includes an identifier 212 of the script that generated the error, an identifier 213 of the error, an indication 214 of the step in the script where the error occurred, a timestamp 216 of the error, an identifier 218 of the storage processor 102 where the error was generated, and a note 220 that describes the nature of the error and/or possible ways of resolving the error. In the present example, pressing the OK button 206 may cause screen 200 to be dismissed, and pressing the HELP button 204 may cause a further help screen to be displayed. FIG. 2 is provided to illustrate one possible example of an error message that can be generated in the storage system 104. However, it will be understood that the present disclosure is not limited to any specific type of content being part of an error message.

FIG. 3 is a diagram of an example of management system 140, according to aspects of the disclosure. As illustrated, management system 140 may include a memory 310, a processor 320, and a communications interface 330. Memory 310 may include any suitable type of volatile or non-volatile memory, such as a solid-state drive (SSD), a hard disk (HD), a random-access memory (RAM), a Synchronous Dynamic Random-Access Memory (SDRAM), etc. Processor 320 may include any suitable type of processing circuitry, such as one or more of a general-purpose process (e.g., an x86 processor, a MIPS processor, an ARM processor, etc.), a special-purpose processor, an application-specific integrated circuit (ASIC), a field programmable gate array (FPGA), etc. The communications interface 330 may include any suitable type of communications interface. By way of example, the communications interface 330 may include one or more of an InfiniBand host bus adapter, an Ethernet adapter, or a Bluetooth adapter for example.

The processor may be configured to execute a solution manager 326, and an error interface 328. Solutions manager 326 may include any suitable type of software that is arranged to manage, configure, and maintain storage system 104. In one example, the solution manager 326 may include a user interface 402 and a backend 404. Error interface 328 (hereinafter “interface 328”) may include software that is configured to detect error messages that are generated in storage system 104 and provide the error messages to solution manager 326. The programs that generate the error messages may include any suitable type of program that is executed on one of the storage processors 102, the management system 140 and/or any other computing device that is part of storage system 104. By way of example, the program may include network-accessible storage (NAS) servers, hypervisors, guest operating systems that are executed inside the hypervisors, software that captures snapshots of a logical unit, software that performs data replication, and/or any other suitable type of software. Although, in the example of FIG. 3, interface 328 is executed on management system 140, alternative implementations are possible in which one or more instances of interface 328 are executed on any of storage processors 102 and/or any computing device that is part of storage system 104. Although, in the example of FIG. 3, interface 328 is depicted as a separate block, in some implementations, interface 328 may be integrated into the software whose errors it is arranged to report to solution manager 326. Stated succinctly, the present disclosure is not limited to any specific implementation of interface 328 for as long as interface 328 is configured to: (i) detect an error that is generated by a software program and (ii) provide the error to solution manager 326. Providing the error to solution manager 326 may include providing to solution manager 326 at least some of the information that is part of an error message corresponding to the error. The error message may be the same or similar to the error message 202 that is shown in FIG. 2. In this regard, providing the error may include providing one or more of an identifier of the error (e.g., an error code), an identifier of the script that generated the error, an indication of a timestamp of the error, an identifier of the storage processor where the error was generated, an identifier of a script line where the error occurred, and/or a note that describes the nature of the error or possible ways of resolving the error.

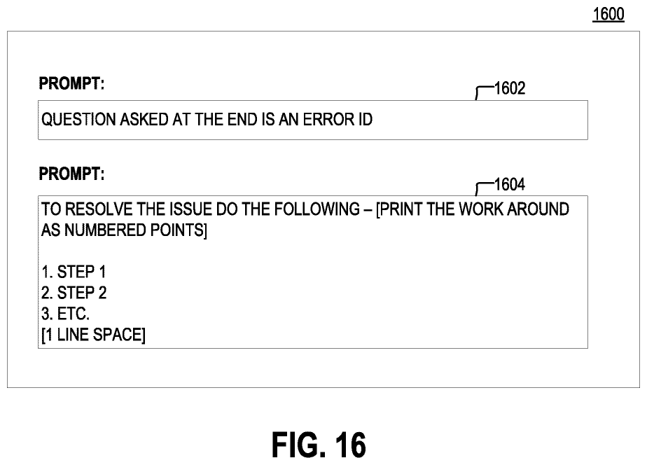

FIG. 4 shows an example of the internal processing system 142, according to aspects of the disclosure. As illustrated, system 142 may be configured to execute an artificial intelligence (AI) engine 322, a trainer 323, and a large language model (LLM) engine 324 (hereinafter “LLM 324”). AI engine 322 may include software that implements a neural network or another machine learning model. By way of example, AI engine may implement one or more feedforward neural networks (FNNs), one or more a convolutional neural networks (CNNs), one or more recurrent neural networks (RNN), and/or any other suitable type of neural network. Trainer 323 may include software configured to train AI engine 322. In some implementations, trainer 323 may include a graphical user interface (GUI) for specifying various system parameters for LLM 324. Furthermore, trainer 323 may include a GUI for specifying prompt engineering information. An example of one such GUI is screen 1600, which is shown in FIG. 16. Engine 324 may include an engine that implements a large language model (LLM). According to the present example, LLM 324 is a Chat GPT TM engine. However, the present disclosure is not limited to any specific implementation of LLM 324. The internal processing system 142 may be configured to store in memory a training data store 312 and a vector store 314. The training data store 312 may be a database where training data, which is used for training AI engine 322, is stored. The vector store 314 may be a database where embeddings that are generated by AI engine 322 are stored. Although, in the example of FIG. 4, training data store 312 and vector store 314 are stored in the memory of management system 140, in alternative implementations any of training data store 312 and vector store 314 may be stored remotely.

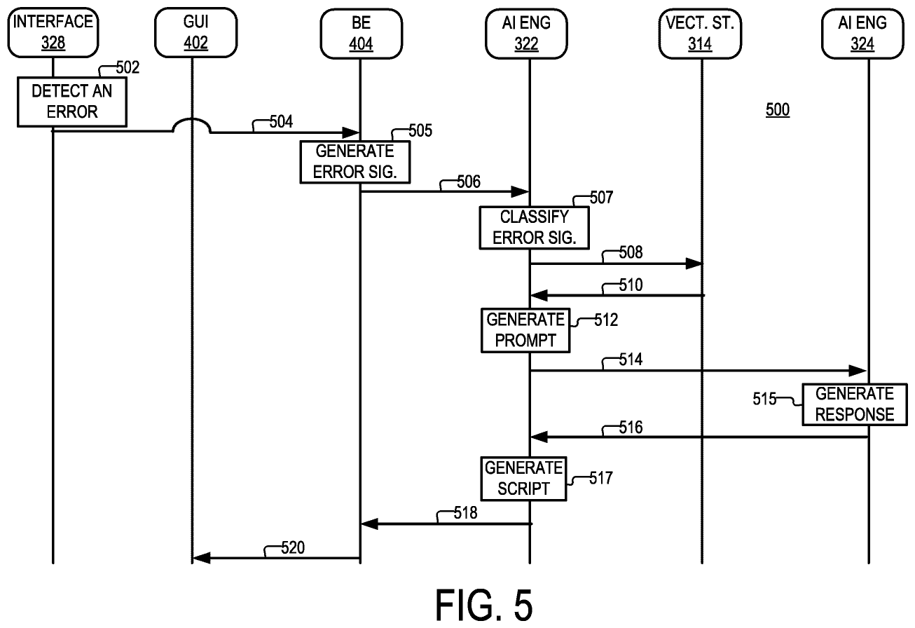

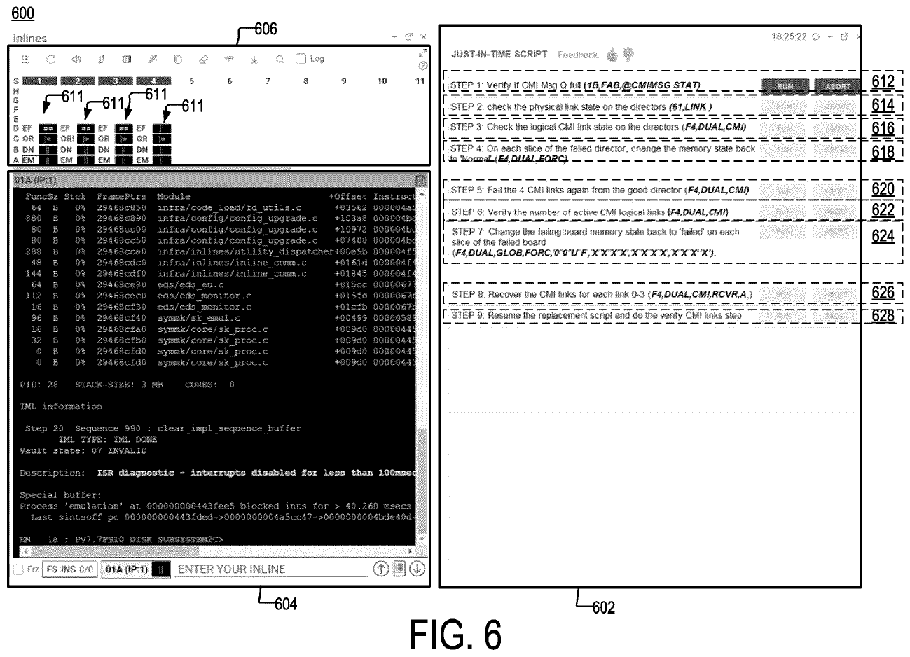

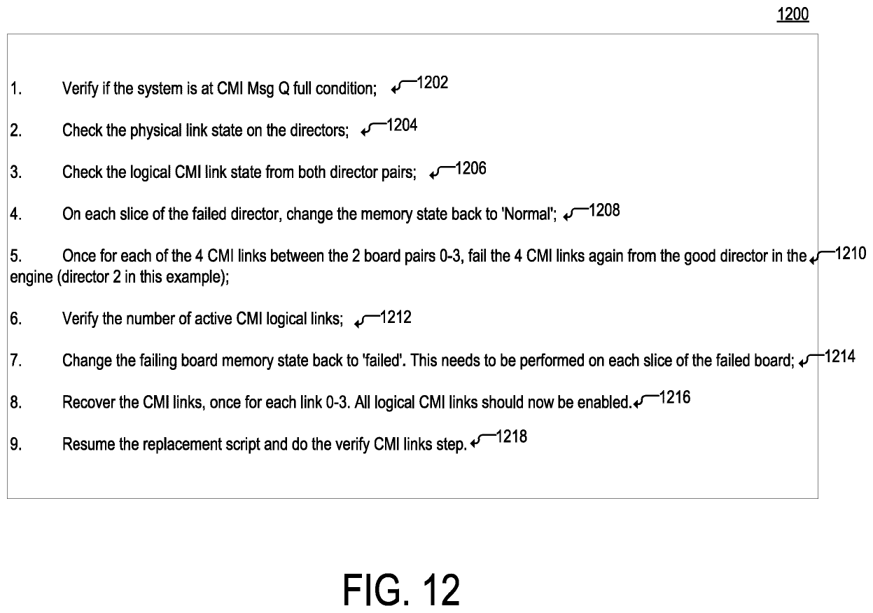

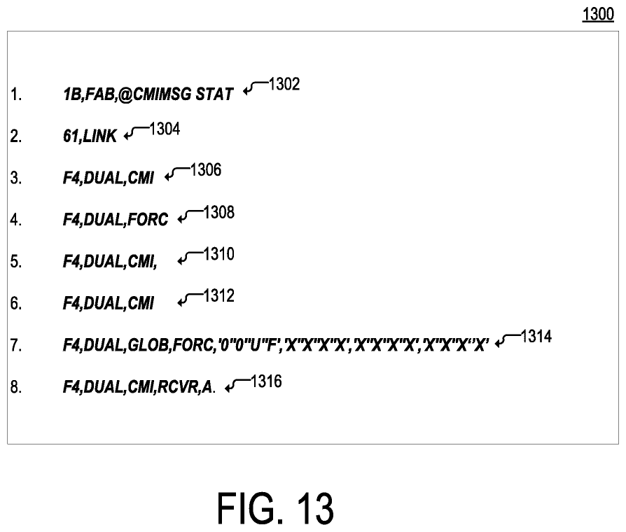

FIG. 5 is a sequence diagram of an example of a process 500, according to aspects of the disclosure. At step 502, interface 328 detects an error. At step 504, interface 328 provides the error to backend 404. At step 505, backend 404 generates a signature of the error. The signature may include any suitable type of representation of the error that is receivable by AI engine 322. At step 506, backend 404 provides the signature to AI engine 322. At step 507, AI engine 322 classifies the signature into one of a plurality of categories, where each category corresponds to a different embedding in the vector store 314. At step 508, AI engine 322 requests from the vector store 314 the embedding, whose category the signature is classified into. At step 510, AI engine 322 receives the embedding from vector store 314. At step 512, AI engine 322 generates a prompt based on the received embedding. At step 514, AI engine 322 provides the prompt to AI engine 322. At step 515, LLM 324 generates a response to the prompt. The answer may be the same or similar to the response 1200, which is discussed further below with respect to FIG. 12. At step 516, LLM 324 provides the response to AI engine 322. At step 517, AI engine 322 generates a script based on the response. The script may be the same or similar to the script 1300, which is discussed further below with respect to FIG. 13. At step 518, AI engine 322 provides the script to the backend 404. At step 520, backend 404 generates a script execution screen 600 (shown in FIG. 6) based on the script and causes user interface 402 to display the screen 600.

FIG. 6 is a diagram of a script execution screen 600 (hereinafter “screen 600”), according to aspects of the disclosure. As illustrated, screen 600 may include portions 602, 604, and 606. Portion 602 may include visualization items 612-626. Each of visualization items 612-626 may correspond to a different line in the script (generated at step 517). Each of items 612-626 may contain a textual description (or a text label) corresponding to that item's respective script line. In addition, each of items 612-626 may include a different respective RUN button and a different respective ABORT button. Pressing the RUN button may cause the backend 404 to execute the item's corresponding script line. Pressing the ABORT button may stop executing the script or notify backend 404 that the script line contains an error.

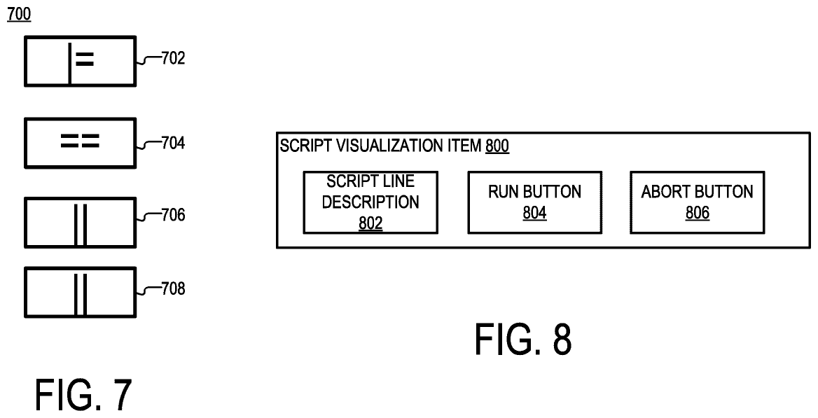

Portion 604, may include a terminal console where the result of the execution of any of the lines in the script is displayed. Portion 606, may identify the status of the storage processors 102 in storage system 104. Portion 606 may include a plurality indicator columns 611. Each indicator column 611 may correspond to a different storage processor 102 (or a different board within a storage processor) in the storage system 104. Each indicator column 611 may include a plurality of status indicators, where each status indicator indicates the current status of a different emulation that is executed on the indicator column's 611 corresponding storage processor 102. Each of the indicator columns 611 may be the same or similar to the indicator column 700, which is discussed further below with respect to FIG. 7.

FIG. 7 is a schematic diagram of an indicator column 700, according to aspects of the disclosure. As illustrated, indicator column 700 may include status indicators 702, 704, 706, and 708. Each of the status indicators 702-708 corresponds to a different emulation (or virtualized container) that is executed on the same storage processor 102. Each of the status indicators 702-708 may contain a symbol indicating the condition of the status indicator's corresponding emulation. In the example of FIG. 7, the symbols “==”, “∥”, and “|=” indicate the operational status of the emulation. In one example, the symbol of “|=” means that the status indicator's corresponding emulation is not ok, but working; and the symbol of “∥” means that the indicator's corresponding emulation has experienced an error.

FIG. 8 is a script visualization item 800 (hereinafter “item 800”), according to aspects of the disclosure. Item 800 may be the same or similar to any of the items 612-628, which are discussed above with respect to FIG. 6. As illustrated, item 800 may include a script line description 802, a RUN button 804, and an ABORT button 806.

The script line description 802 may include a text label or another similar user interface component that identifies, or otherwise describes, a line in a script. Furthermore, the description may identify a maintenance action that involves a physical interaction with hardware, which needs to be performed by a CS engineer before the script line is executed. The maintenance action may involve “removing a particular board or other hardware from a storage processor enclosure”, “installing a new board or other hardware,” physically unplugging a cable, physically plugging a cable, and/or any other suitable action. In sum the description may identify one or more of: (i) “an action that would be performed (or a result that would be achieved) when a script line is executed” and (ii) a physical action that needs to be performed before the physical line is executed. For example, the description may provide “remove graphics card A and then press the RUN button to uninstall the driver for graphics card A”.

The script may be a script that is generated by using AI engines 322 and 324. The script may be generated in the manner discussed with respect to FIG. 5 and FIGS. 11-14. The script line may include a command for a maintenance utility or another type of program. The maintenance utility (or other program) may be executed on one or more of the management system 140, any of the storage processors 102, and/or any other suitable type of computing device that is part of storage system 104. Executing the script line may cause the maintenance utility (or other program) to perform an action. By way of example, the action may include one or more of: terminating a process or service, starting a process or service, changing the value of a configuration setting (e.g., updating a .conf etc., etc.), updating a data structure, and/or any other action that is normally performed by system administrators for the purposes of maintaining or troubleshooting a large-scale computing system. The script line is herein referred to as the “item's 800 corresponding script line.”

RUN button 804 may be arranged to control the execution of the item's 800 corresponding script line. According to the present example, item's 800 corresponding script line would be executed only when RUN button 804 is pressed by the user. The action of RUN button 804 is limited to the item's 800 corresponding script line. Accordingly, pressing the RUN button 804 would have no effect on the execution of the corresponding script lines of other visualization items that are displayed concurrently with visualization item 800. Although, in the present example, user interface component 804 is a button, the present disclosure is not limited to using any specific type of input component to trigger the execution of the item's 800 corresponding script line. For example, in some implementations, RUN button 804 may be replaced with a checkbox or a slider.

ABORT button 806 may be arranged to stop the execution of the item's 800 corresponding script line. According to the present example, pressing ABORT button 806 may cause the execution of item's 800 corresponding script line, assuming the script line has started. Additionally or alternatively, pressing the ABORT button 806 may notify backend 404 that the item's 800 corresponding script line contains an error. In some implementations, pressing the abort button 806 may stop the execution of the entire script. In one example, when the abort button is pressed, this may be recorded as the receipt of negative feedback for the operation of solutions manager 326, which can be subsequently used by domain experts to improve the operation of solutions manager 326. Although, in the present example, user interface component 806 is a button, the present disclosure is not limited to using any specific type of input component to abort the execution of the item's 800 corresponding script line. For example, in some implementations, ABORT button 806 may be replaced with a checkbox or a slider.

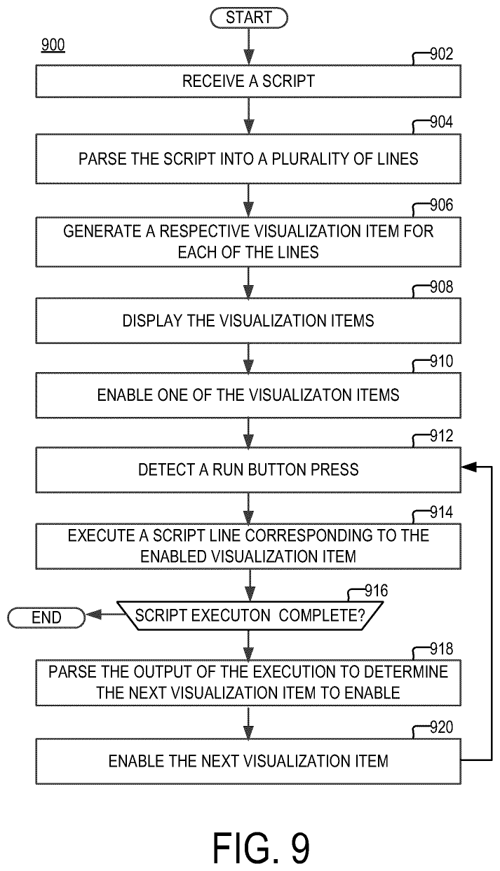

FIG. 9 is a flowchart of an example of a process 900 for displaying and using the screen 600, according to aspects of the disclosure.

At step 902, backend 404 receives a script (e.g., a healing script). The script (e.g., the healing script) may be generated in the manner discussed with respect to FIG. 5 and FIGS. 11-14. At step 904, backend 404 parses the script into a plurality of lines. Each of the lines may be capable of executed separately of the rest. At step 906, backend 404 generates a different respective visualization item for each of the script lines (identified at step 904). According to the present example, visualization items 612-628 are generated. At step 908, the screen 600 is displayed, and visualization items 612-628 are displayed in portion 602 of screen 600. At step 910, a first one of the visualization items is enabled. As used herein, the phrase “enabling a visualization item” refers to enabling the RUN button that is part of the visualization item. In some implementations, when step 912 is executed, the remaining visualization items (other than the first visualization items) may be disabled, meaning that their respective RUN buttons may not be capable of being clicked. In other words, in some implementations, at any given time, only one of the visualization items that are displayed (or its corresponding RUN button) may be enabled. At step 912, backend 404 detects that the RUN button which is part of the most recently enabled visualization item is pressed. At step 914, in response to the RUN button being pressed, backend 404 executes the visualization item's corresponding script line (i.e., the script line corresponding to the visualization item that is selected at step 910 or the most recent iteration of step 918. At step 916, backend 404 determines whether the execution of the script is completed. If the execution is completed, process 900 ends. Otherwise, process 900 proceeds to step 918. At step 918, the output of the execution of the script line (at step 914) is processed to determine the next visualization item to enable. At step 920, the visualization item identified at step 918 is enabled, after which the process 900 returns to step 912.

FIGS. 6-9 provide an example of a user interface 402, which is suitable for use in conjunction with scripts that are generated, at least in part, by using large language models. As is well known, LLMs are susceptible to hallucinations. In the context of LLMs, the term “hallucination” refers to the generation of text information that is factually incorrect, misleading, or nonsensical, even though it may seem plausible or well-structured. Common types of hallucinations include fabricating facts, inventing non-existent entities, or interpreting context.

As noted above, the user interface 402 may include the screen 600. The screen 600 may be used to present a CS engineer, or any other user, with a script that is generated by using a large language model. The large language model may be implemented by LLM 324. The user interface includes a separate RUN button for each of the lines in the script. The user interface 402 executes each of the lines in the script, if and only if, that line's respective RUN button is pressed (provided that the line contains an executable command). In other words, the user interface 402 may hold off on executing any of the lines in the script until that line's respective RUN button is pressed. This allows CS engineers with the opportunity to examine each script line carefully before executing the line, in order to ensure that the line is not the result of hallucinations. In a nutshell, screen 600 is advantageous because it facilitates careful examination of an automatically generated script to ensure that the script does not contain hallucinations or other errors.

In another respect, the user interface 402 may enable the respective RUN button for each line only when all preceding script lines have been executed. This ensures that the lines in the script are not going to be executed out of order.

In yet another aspect, the items 612-628 may be displayed in the order in which their corresponding script lines occur in the script. For example, starting from top to bottom, the visualization item corresponding to the first line in the script (e.g., item 612) may be displayed first, the visualization item corresponding to the second line in the script (e.g., item 614) may be displayed second, the visualization item corresponding to the third line in the script (e.g., item 616) may be displayed third, and so forth.

As used throughout the disclosure, the term “script” may refer to a set of commands. In some implementations, each of the commands may be executable by a different software utility in storage system 104. Alternatively, in some implementations, each of the commands may be executable by the same software utility in storage system 104. In yet other implementations, at least two of the commands in the script may be executable by different software utilities.

In the example of FIGS. 6 and 9, all lines in the script contain an executable command. However, in some implementations, one or more of the lines in the script may be associated with a physical action, such as the removal of a particular board or other hardware component and its replacement with a new component. In such implementations, the visualization item corresponding to such a line may also be provided with a RUN button. However, pressing the RUN button would not cause any command to be executed. Rather, pressing the RUN button would notify user interface 402 that the physical action has been completed, after which user interface 402 may carry on by enabling the RUN button for the next line in the script.

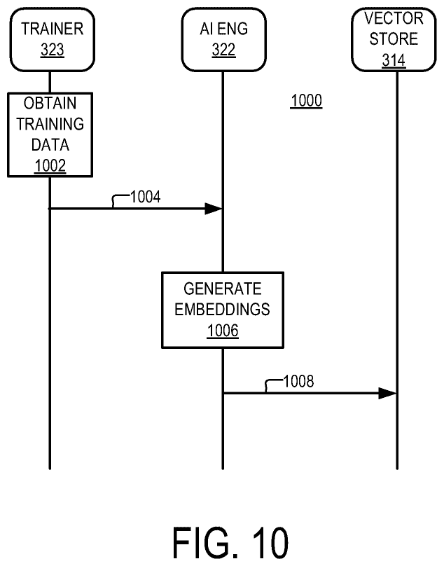

FIG. 10 is a sequence diagram of an example of a process 1000, according to aspects of the disclosure. At step 1002, trainer 323 obtains training data. At step 1004, trainer 323 provides the training data to AI engine 322 and places one or more application programming interface (API) calls to AI engine 322, which, when executed, would cause engine 322 to execute a training procedure based on the training data. At step 1006, AI engine 322 generates a plurality of embeddings based on the training data. At step 1008, AI engine 322 stores the generated embeddings in vector store 314.

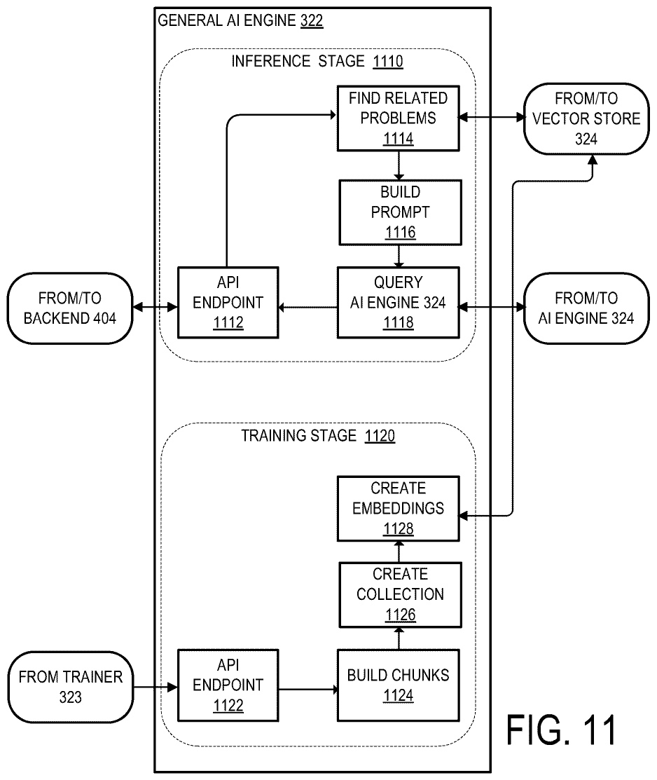

FIG. 11 is a diagram of an example of AI engine 322, according to aspects of the disclosure. As illustrated, AI engine 322 may include an inference stage 1110 and a training stage 1120.

Training stage 1120 may include an API endpoint 1122 and modules 1124-1128. API endpoint 1122 may provide an application programming interface for batch-feeding AI engine 322 with a sanitized training dataset. Module 1124 may be configured to break the training dataset into chunks. Module 1126 may be configured to organize the chunks into collections. And module 1128 may be configured to generate a different respective embedding based on each of the collections. In addition, module 1128 may be configured to store the collected embeddings in vector store 314. According to the present example, each of modules 1124-1128 is implemented in software. However, alternative implementations are possible in which any of modules 1124-1128 is implemented in hardware or as a combination of software and hardware.

The training data set may include articles describing error codes and published solutions. By way of example, the training dataset may include DELL PowerMax's™ Redbox Confluence pages, cleaned knowledge base articles, cleaned Salesforce™ articles, and/or other documents that have been written/reviewed by domain experts. Additionally or alternatively, the training data may include Redbox™ recordings, descriptions of valid system calls, description of inline calls (or other types of executable commands), examples of existing scripts (e.g., existing healing scripts)and their description, and/or any other suitable information. Redbox™ is a tool that is used in the management of PowerMax™ systems, (iii) information on how to interpret inline calls, and (iv) prompt engineering information. The prompt engineering information may include an indication of the format which prompts generated by AI engine 322 must follow. Redbox can be outfitted with a recording capability which records (i) information that is received as input by the tool, and (ii) any user input that is provided into the tool. In this regard, the recording capability may be configured to generate a plurality of recordings of the user interactions with the tool, wherein each recording contains information associated with a particular problem, as well as the steps that are taken by the user to resolve the problem. The term “inline call” refers to a type of call that is implemented by various utilities in PowerMax™. In general, inline calls may be used to turn off or on a service in a storage system or perform any other suitable action.

Inference stage 1110 may include an API endpoint 1112 and modules 1114-1118. API endpoint 1112 may provide an interface for receiving, from backend 404, an error signature and returning, to backend 404, a script for resolving (or otherwise addressing) the error corresponding to the error signature. The error signature may be the same or similar to the error signature generated at step 505 of process 500 (shown in FIG. 5). The script may be the same or similar to the script that is generated at step 517 of process 500.

Module 1114 may be configured to find problems that are related to the error associated with the error signature (hereinafter “instant error”). The error signature may correspond to an error that is associated with an error message. More precisely, the task of finding related problems may entail classifying the error signature into one of a plurality of categories, wherein each category corresponds to a different set of keywords and/or key phrases. In some implementations, each keyword or key phrase may identify a related problem or a related solution to the error signature. For example, the instant error may contain the following error message: “Not same EMULation files on the CS and the SYMM! This may indicate that new released package was installed on the CS but the new code was never loaded to the Symm,” error code: 1602”. In this example, each of the keywords or key phrases that are obtained by module 1114 may identify a cause or a solution to the error code and/or any of the issues that are identified in the error message. For example, for the error message at hand, module 114 may obtain the key phrase “load a new release package”.

Module 1116 may be configured to generate a prompt based on one or more of the keywords and key phrases that are obtained by module 1114. The prompt may be a natural language snippet (e.g., a sentence or several sentences) that requests a set of steps that implement a solution to the error. For example, when the key phrase obtained by module 1114 is “load a new release package”, the prompt may include the text of “identify a set of steps that need to be performed in order to load a new release package”. The prompt may further include an identifier of the release package and/or any other suitable type of information that is found in the error message or otherwise obtained by module 1114. In some implementations, the prompt may include a question whose format is specified via field 1602 of screen 1600 (shown in FIG. 16). Additionally or alternatively, the prompt may include a set of instructions that specify the format of the response which will be produced by LLM 324. For example, the instructions may include the text which is shown in field 1604 of screen 1600. In some implementations, module 1116 may be implemented by using a neural network that is trained to receive as input one or more of: (i) the error message and (ii) any keywords that are obtained by module 1114, and generate a prompt in response.

Additionally or alternatively, the prompt may be generated by using rule-based logic. The rule-based logic may specify pre-determined questions with place-holders for error-specific information. For example, the rule-based logic may include the following question template: “Provide a solution for the error having the error code of <error_code>”. Upon executing the rule-based logic, module 116 may replace the tag <error_code> with the actual error code of the error and insert the resultant text into the prompt. It will be understood that rule-based logic may specify multiple questions or other statement templates. Each template may include a placeholder for any item of information that is part of the error message and/or any keyword or key phrase that is obtained by module 1114. Executing the rule-based logic may cause each template to be populated with a portion of the message and/or a key phrase or keyword that is obtained by module 1114. Afterwards, the templates are populated, the resultant text may be included into the prompt.

In some respects, building a concise and specific prompt is key to generating accurate responses. A prompt may include a role, action, tone, format, and context. The prompt needs to be task specific, and clear on intent. Sample output format controls the information needed, in the response. In this regard, in some implementations, the above approach may enable module 1116 to utilize a set of pre-built prompts and a set of pre-built sample formats to fine-tune the accuracy. For example, the prompt for “Tell me about CMI logical Links” is different than “How do I fix the CMI logical Links?”. Sample prompt for “Tell me about CMI logical Links” could be “Question asked is about a software element. Start your answer with the name of the software element and its description”. Sample prompt for “How do I fix the CMI logical Links?” could be “Question asked is a software element. From the given context, check if any workaround steps are present. End your answer after printing the list of contacts.”

Module 1118 may be configured to provide the prompt to LLM 324. In addition, the module 1118 may be configured to receive from LLM 324 an answer to the prompt. According to the present example, a response 1200 is received, an example of which is shown in FIG. 12. As illustrated, the response 1200 may identify steps 1202-1218. Each one of steps 1202-1218 may be a natural language text description of an action that needs to be performed by a CS engineer (or another professional) for the purpose of addressing the instant error.

Module 1118 may be further configured to generate a script based on the response 1200. According to the present example, a script 1300 is generated, an example of which is shown in FIG. 13. As illustrated, the script 1300 may include script lines 1302-1316. In the example of FIG. 13, line 1302 is generated based on step 1202 and it includes an executable command that performs the action described by step 1202; line 1304 is generated based on step 1204 and it includes an executable command that performs the action described by step 1204; line 1306 is generated based on step 1206 and it includes an executable command that performs the action described by step 1206; line 1308 is generated based on step 1208 and it includes an executable command that performs the action described by step 1208; line 1310 is generated based on step 1210 and it includes an executable command that performs the action described by step 1210; line 1312 is generated based on step 1212 and it includes an executable command that performs the action described by step 1212; line 1314 is generated based on step 1214 and it includes an executable command that performs the action described by step 1214; line 1316 is generated based on step 1216 and it includes an executable command that performs the action described by step 1216. As noted above, in some implementations, not all steps in the response 1200 may be capable of being translated to an executable command.

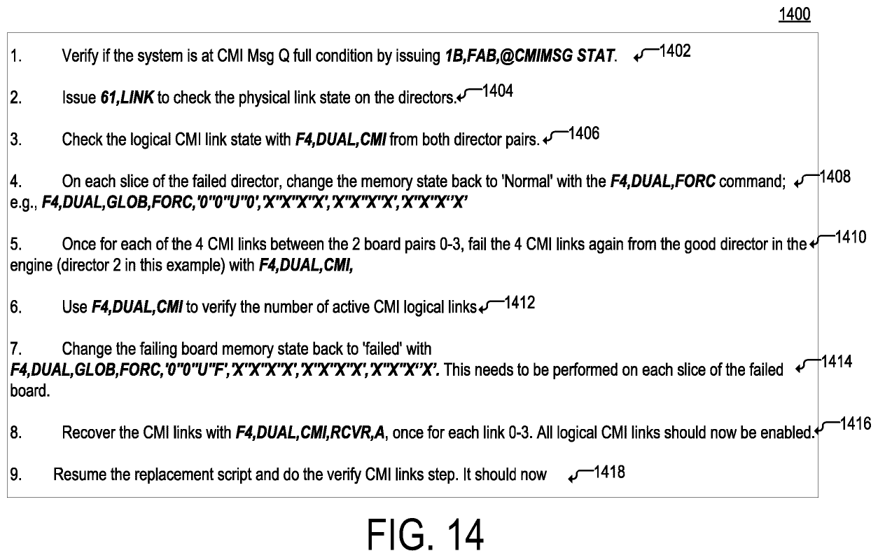

Module 1118 may be further configured to combine the response 1200 with the script 1300 to produce a label set 1400, an example of which is shown in FIG. 14. As illustrated, the label set 1400 may include labels 1402-1404. Each of the labels 1402-1418 may correspond to a different one of the steps 1202-1218 in the response 1200. Each of the labels 1402-1418 may be generated by combining its corresponding step with the script line that is generated based on the step (provided that such script line is available). In the example of FIG. 14, label 1402 is generated by combining step 1202 with script line 1302; label 1404 is generated by combining step 1204 with script line 1304; label 1406 is generated by combining step 1206 with script line 1306; label 1408 is generated by combining step 1208 with script line 1308; label 1410 is generated by combining step 1210 with script line 1310; label 1412 is generated by combining step 1212 with script line 1312; label 1414 is generated by combining step 1214 with script line 1314; label 1416 is generated by combining step 1216 with script line 1316; and label 1418 is generated based on step 1218.

Module 1118 may provide the script 1300 and/or label set 1400 to backend 404. In some implementations, backend 404 may be configured to generate each of the visualization items 612-624 based on a different one the labels 1402-1418. Visualization item 612 may be generated based on label 1402 and/or script line 1302. For instance, the script line description of item 612 may be identical to (or otherwise generated based on) label 1402, and the run button of item 612 may be linked to script line 1302, such that when the run button is pressed, script line 1302 would be executed by management system 140 (and/or another computing device that is part of storage system 104). Visualization item 614 may be generated based on label 1404 and/or script line 1304. For instance, the script line description of item 614 may be identical to (or otherwise generated based on) label 1404, and the run button of item 614 may be linked to script line 1304, such that when the run button is pressed, script line 1302 would be executed by management system 140 (and/or another computing device that is part of storage system 104). Visualization item 616 may be generated based on label 1406 and/or script line 1306. For instance, the script line description of item 616 may be identical to (or otherwise generated based on) label 1406, and the run button of item 616 may be linked to script line 1306, such that when the run button is pressed, script line 1306 would be executed by management system 140 (and/or another computing device that is part of storage system 104). Visualization item 618 may be generated based on label 1408 and/or script line 1308. For instance, the script line description of item 618 may be identical to (or otherwise generated based on) label 1408, and the run button of item 618 may be linked to script line 1308, such that when the run button is pressed, script line 1308 would be executed by management system 140 (and/or another computing device that is part of storage system 104). Visualization item 620 may be generated based on label 1410 and/or script line 1310. For instance, the script line description of item 620 may be identical to (or otherwise generated based on) label 1410, and the run button of item 620 may be linked to script line 1310, such that when the run button is pressed, script line 1310 would be executed by management system 140 (and/or another computing device that is part of storage system 104). Visualization item 622 may be generated based on label 1412 and/or script line 1312. For instance, the script line description of item 622 may be identical to (or otherwise generated based on) label 1412, and the run button of item 622 may be linked to script line 1312, such that when the run button is pressed, script line 1312 would be executed by management system 140 (and/or another computing device that is part of storage system 104). Visualization item 624 may be generated based on label 1414 and/or script line 1314. For instance, the script line description of item 624 may be identical to (or otherwise generated based on) label 1414, and the run button of item 624 may be linked to script line 1314, such that when the run button is pressed, script line 1314 would be executed by management system 140 (and/or another computing device that is part of storage system 104). Visualization item 626 may be generated based on label 1416 and/or script line 1316. For instance, the script line description of item 626 may be identical to (or otherwise generated based on) label 1416, and the run button of item 626 may be linked to script line 1316, such that when the run button is pressed, script line 1316 would be executed by management system 140 (and/or another computing device that is part of storage system 104). Visualization item 628 may be generated based on label 1418, and it may lack an executable command linked to it.

In some implementations, when the response provided by LLM 324 is a mix of software actions and hardware touch-points (e.g., actions that require the physical replacement of hardware or other physical interactions with hardware), solution manager 326 may generate a service request, such as a request for new HW to be sent from vendor to customer. Furthermore, solution manager 326 may also generate a script to handle the hardware replacement (after the new hardware is delivered). Once the new hardware is delivered, a CS engineer may execute the script to replace the hardware and to recover the system.

In some implementations, solution manager 326 may be configured to receive user feedback on generated scripts, which can be recorded and weighted. When the user provides negative feedback, a notification (ex: email) will be sent to a domain training engineering team that is in charge of updating the vector store 314. Furthermore, in some implementations, the model utilized by solution manager 326, which involves communicating to the user actions and intentions of generated scripts in simple language, and receiving feedback from the user on the generated scripts, may implement a feedback loop that uses scripts which are generated by solution manager 326 in its future training and optimization.

In some implementations, solution manager 326 may also collect: (1) the time when generated scripts are executed, (2) information about any errors that are generated as a result of the execution of the scripts, and (3) the system configuration of the devices/systems on which the scripts are executed. In some implementations, the vector store 314 may also contain embeddings related the same error code and different configurations and solutions to diagnose and heal the system.

In some implementations, solutions manager 326 may be arranged to generate a health check script based on often-seen errors in a particular type of configuration. The health check script may be placed on a scheduler to run unattended. Based on the result of running the health check script, a healing script could be generated and added to the task list for the CS engineer. The system could estimate how long the script would take to run and providing a better script progress view to the user.

As used throughout the disclosure, the term “script” may refer to any of the script displayed in screen 600 (shown in FIG. 6), the script 1300 which is shown in FIG. 13, and the set of labels 1400, which is shown in FIG. 14. Similarly, the term “script” may refer to any of the script displayed in screen 600 (shown in FIG. 6), the script 1300 which is shown in FIG. 13, and the set of labels 1400, which is shown in FIG. 14. Although the examples of FIGS. 1-14 are presented in the context of a storage system, it will be understood that the ideas and concepts presented throughout the disclosure can be applied towards troubleshooting any computing system.

Referring to FIG. 15, in some embodiments, a device 1500 may include processor 1502, volatile memory 1504 (e.g., RAM), non-volatile memory 1506 (e.g., a hard disk drive, a solid-state drive such as a flash drive, a hybrid magnetic and solid-state drive, etc.), graphical user interface (GUI) 1508 (e.g., a touchscreen, a display, and so forth) and input/output (I/O) device 1520 (e.g., a mouse, a keyboard, etc.). Non-volatile memory 1506 stores computer instructions 1512, an operating system 1516 and data 1518 such that, for example, the computer instructions 1512 are executed by the processor 1502 out of volatile memory 1504. Program code may be applied to data entered using an input device of GUI 1508 or received from I/O device 1520.

FIGS. 1-15 are provided as an example only. In some embodiments, an I/O request may refer to a data read or write request. At least some of the steps discussed with respect to FIGS. 1-15 may be performed in parallel, in a different order, or altogether omitted. As used in this application, the word “exemplary” is used herein to mean serving as an example, instance, or illustration.

FIG. 16 is a diagram of an example of a screen 1600, which is part of the GUI of trainer 323. The screen may include text input fields 1602 and 1604. Field 1602 may specify at least one question that is to be inserted in a prompt that is generated by AI engine 322 and provided to LLM 324. Field 1604 may specify the format which a response by LLM 324 to the prompt must have.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard (4/8).

It will be further understood that various changes in the details, materials, and arrangements of the parts which have been described and illustrated in order to explain the nature of the claimed invention might be made by those skilled in the art without departing from the scope of the following claims.

1. A method for use in a computing system, comprising:
detecting an error;
generating a healing script;
parsing the healing script to identify a plurality of script lines;
displaying a user interface screen that includes a plurality of visualization items, wherein each of the visualization items corresponds to a different one of the plurality of script lines and includes a respective label corresponding to the script line and a respective user interface component, which, when activated, would cause the computing system to execute the script line; and
executing the healing script, wherein executing the healing script includes executing each of the script lines only when the respective user interface component that is part of the script line's corresponding visualization item is activated.

2. The method of claim 1, wherein the respective user interface component of any of the visualization items incudes a RUN button, and activating the respective user interface component includes pressing the RUN button.

3. The method of claim 1, wherein at least two of the script lines include commands that are executable by different utilities in the computing system.

4. The method of claim 1, wherein the user interface screen includes a terminal console that is configured to output information that is generated as a result of executing any of the plurality of script lines.

5. The method of claim 1, wherein generating the healing script includes:
generating a prompt based on the error by using a first artificial intelligence (AI) engine;
providing the prompt to a second AI engine that implements a large language model (LLM);
receiving a response to the prompt from the second AI engine; and
generating the healing script based on the response by using the first AI engine.

6. The method of claim 5, wherein:
the response incudes a respective natural language description for each of a plurality of steps, each of the plurality of steps describing an action that needs to be performed to address the error; and
generating the healing script includes identifying a respective executable command for at least a respective one of the steps, the respective executable command being a command, which, when executed, would cause the computing system to perform the action that is described by the respective step.

7. The method of claim 5, wherein the first AI engine is trained based on at least one of:
(i) knowledge base articles, (ii) recordings of interactions of maintenance personnel with a maintenance utility, and (iii) existing healing scripts and descriptions of the healing scripts.

8. A method for use in a computing system, comprising:
detecting an error;
generating a prompt based on the error by using a first artificial intelligence (AI) engine;
providing the prompt to a second AI engine that implements a large language model (LLM);
receiving a response to the prompt from the second AI engine;
generating a healing script based on the response by using the first AI engine; and
executing the healing script.

9. The method of claim 8 wherein:
the response incudes a respective natural language description for each of a plurality of steps, each of the plurality of steps describing an action that needs to be performed to address the error; and
generating the healing script includes identifying a respective executable command for at least a respective one of the steps, the respective executable command being a command, which, when executed, would cause the computing system to perform the action that is described by the respective step.

10. The method of claim 8, wherein the first AI engine is trained based on at least one of:
(i) knowledge base articles, (ii) recordings of interactions of maintenance personnel with a maintenance utility, and (iii) existing healing scripts and descriptions of the healing scripts.

11. The method of claim 8, wherein executing the healing script includes:
parsing the healing script to identify a plurality of script lines;
displaying a user interface screen that includes a plurality of visualization items, wherein each of the visualization items corresponds to a different one of the plurality of script lines and includes a respective label corresponding to the script line and a respective user interface component, which, when activated, would cause the computing system to execute the script line; and
executing each of the script lines only when the respective user interface component that is part of the script line's corresponding visualization item is activated.

12. The method of claim 11, wherein the respective user interface component of any of the visualization items incudes a RUN button, and activating the respective user interface component includes pressing the RUN button.

13. The method of claim 11, wherein at least two of the script lines include commands that are executable by different utilities in the computing system.

14. The method of claim 11, wherein the user interface screen includes a terminal console that is configured to output information that is generated as a result of executing any of the plurality of script lines.

15. A system, comprising:
a memory; and
at least one processor that is operatively coupled to the memory, the at least one processor being configured to perform the operations of:
detecting an error;
generating a healing script;
parsing the healing script to identify a plurality of script lines;
displaying a user interface screen that includes a plurality of visualization items, wherein each of the visualization items corresponds to a different one of the plurality of script lines and includes a respective label corresponding to the script line and a respective user interface component, which, when activated, would cause the system to execute the script line; and
executing the healing script, wherein executing the healing script includes executing each of the script lines only when the respective user interface component that is part of the script line's corresponding visualization item is activated.

16. The system of claim 15, wherein the respective user interface component of any of the visualization items incudes a RUN button, and activating the respective user interface component includes pressing the RUN button.

17. The system of claim 15, wherein at least two of the script lines include commands that are executable by different utilities in the system.

18. The system of claim 15, wherein the user interface screen includes a terminal console that is configured to output information that is generated as a result of executing any of the plurality of script lines.

19. The system of claim 15, wherein generating the healing script includes:
generating a prompt based on the error by using a first artificial intelligence (AI) engine;
providing the prompt to a second AI engine that implements a large language model (LLM);
receiving a response to the prompt from the second AI engine; and
generating the healing script based on the response by using the first AI engine.

20. The system of claim 19, wherein:
the response incudes a respective natural language description for each of a plurality of steps, each of the plurality of steps describing an action that needs to be performed to address the error; and
generating the healing script includes identifying a respective executable command for at least a respective one of the steps, the respective executable command being a command, which, when executed, would cause the system to perform the action that is described by the respective step.
